(19) United States
(12) Patent Application Publication
(10) Pub. No.: US 2005/0021975 A1
(43) Pub. Date: Jan. 27, 2005

(54) Proxy based adaptive two factor authentication having automated enrollment

(76) Inventor: Gouping Liu, Highlands Ranch, CO (US)

Correspondence Address: THOMAS W. HANSON, LLC, 3990 S. CHEROKEE ST., ENGLEWOOD, CO, 80110, US

(21) Appl. No.: 10/463,369

(22) Filed: Jun. 16, 2003

(51) Int. Cl. H04K 1/00

(52) U.S. Cl. 713/182

(57) ABSTRACT

A method of and system for adding strong authentication to an existing network based application. A proxy based monitoring process screens data sent to and from a client application and intercepts login requests. These intercepted requests are redirected to an authentication process which first checks to see if the user logging in has enrolled in strong authentication. If not enrolled, the user is allowed to continue with a normal login. If enrolled, the user is authenticated by requesting digital identification data, such as a digital certificate, from the user's computer. If authentication succeeds, the user is allowed to proceed on to the normal login process. If authentication fails, the login attempt is blocked. User enrollment is automated, requiring no user interaction beyond the initial request. Verification for purposes of issuing a digital certificate, or other identifying data, is by means of confirming that the user being enrolled is currently logged in to the client application.

### BACKGROUND OF THE INVENTION

1. Field of the Invention

The present invention relates to the field of entity authentication and specifically to authentication of users attempting to access a network accessible resource. Even more specifically it relates to such authentication methods and/or systems which automatically enroll users for a strong authentication method.

2. Background Information

The conventional architecture of a network based application, as shown in FIG. 10, is now well known. The application server, 204, hosts the application and provides related services to distributed users such as user 200, via the network, 202. One major concern in such an environment is authenticating the identity of the user and specifically validating that the user has the claimed identity and is authorized to use or access the provided services. While the network in question is often the Internet, this is not required, either in general or for the present invention.

User authentication in this environment is often by the use of passwords or other so called “weak” authentication methods. Such methods are subject to a variety of well known attacks and provide only limited security.

A popular approach to provide stronger user validation for various purposes is to use digital certificates based on a Public Key Infrastructure (PKI). See FIG. 11. This approach uses a public key/private key pair in combination with a cryptographic algorithm. The private key is held securely by the certificate holder, and used to sign, or encrypt, messages. The public key of a certificate holder is freely available and can be used to verify that a message has been signed by or to decrypt a message from the holder of the private key. A digital certificate includes the public key along with other relevant information, such as the name of the certificate holder and the expiration date of the certificate and is digitally signed by a Certificate Authority (CA). The information provided by the certificate holder may have been verified by the CA to a greater or lesser extent. Different types, or levels, of certificates may be issued depending on the level of verification performed.

In use, the digital certificate is issued by the CA, 210, to the message sender and then provided by a message sender, 206, to a message recipient, 208, who verifies the certificate. Alternatively, the certificate may be obtained from another party or the CA directly, prior to verification. Either way, this verification provides a third party confirmation that the public key is bound to the entity named in the certificate. In combination with cryptographic verification that a message was created by the holder of the corresponding private key, this approach provides strong validation of that entity. This type of validation can be used for a wide variety of messages, including user logon, or access, requests.

Where user validation by means of digital certificates is used as the basis of a user authentication scheme, strong authentication can be achieved. One candidate protocol for such a scheme was published by the US National Institute of Standards and Technology (NIST) in 1997 as Federal Information Processing Standard (FIPS) 196, Entity Authentication Using Public Key Cryptography. That standard is incorporated herein by reference. That standard presents both unilateral and mutual entity authentication protocols. For the case of user authentication for a web based application, the unilateral protocol is the most relevant. The details of the protocol are not critical and, if required, can be found in the above standard. In general, the following steps are followed: the user requests access to the server; the server generates a challenge message to the user, including a randomly generated number; on receipt, the user generates its own random number, combines it with the received message and digitally signs the combined message; the signed message is returned to the server; the server verifies that the signed message contains the random number which it generated; verifies the user's certificate; and then verifies the user's digital signature on the returned message. Assuming all steps succeed, the user has been authenticated to the application server. The use of the random numbers is to guard against certain specific threats, the details of which are outside the scope of the present invention and can be found in the above standard.

While the use of a PKI scheme, and digital certificates specifically, for strong authentication, is well known and relatively straight forward, the process of obtaining the certificates for use is sufficiently complex as to deter their use. Traditionally, certificate enrollment was a primarily manual process. As an example, in the VeriSign, Inc. manual issuance process, users connect to an enrollment page and provide personal information, including name, address and organization. The browser generates a public/private key pair and a certificate request and sends them to the Registration Authority, where requests are manually reviewed. Once the enrollment is approved, the users receive e-mail messages specifying web addresses from which to download certificates. The process involves manual processing on the part of both the user and the Registration Authority and can involve delays while the request is reviewed and approved.

The issuance of certain levels of digital certificates has been automated to a degree. These approaches typically cross check user supplied information against an existing database containing that type of information. Typical user information would include name, mailing address, and email address. In the case of VeriSign, this information is currently checked against consumer information maintained by Equifax, Inc. While faster, and involving no manual steps on the part of the Registration Authority, this process still involves much the same manual processing on the part of the requesting user.

Digital certificates may also be issued on a pre-approved basis. This is most often used where a company acts as its own CA for certificates issued to employees. Employees are validated and then issued passcodes which can be used to obtain their digital certificates. A similar arrangement may be made with third party CA's such as VeriSign where a list of pre-qualifed employees is supplied to the CA which, in turn, issues a set of passcodes to be provided to the employees for use in obtaining their certificate directly from the CA.

Conventional password access may be used in combination with digital certificates, above, or other strong authentication methods, such as biometrics, to provide two factor authentication. Multi-factor authentication is also known. Adaptive authentication approaches are known which vary the number or type of factors used in response to changes in perceived need for strength of authentication. Typically the adaptation is controlled by the service provider, but at least one scheme, discussed in An adaptive Authentication Protocol Based on Reputation for Peer-to-Peer System, Lee and Kim, SCIS 2003 Symposium, allows for the user to elect between weak and strong authentication by selecting between a “guest” and user specific account.

Strong authentication, such as that available with digital certificates, is clearly a desirable feature. However, it is not widely utilized due in large part to the complexity and inconvenience involved. The complexity typically occurs on the application side. While API toolkits are provided for many PKI systems, significant effort is still required to implement the functionality required to provide certificate based authentication. Accompanying this complexity is the expense associated with such an implementation and subsequent maintenance. Inconvenience is found primarily on the user side. While some aspects of the CA portion of the enrollment process have been automated, the user must still take several manual steps to request and install a certificate.

There is a need for a simplified approach to providing strong authentication for an existing application. It should require minimal user effort and minimal modification to the application. Ideally a “one click” interface to the user should be supported, where no information entry is required. Also ideally, the authentication should be provided to the application with no modification of the application itself. The entire enrollment and authentication process would proceed with no human intervention once the system has been implemented. Further, the method should be adaptive to accommodate either strong or weak authentication for different users and to provide an easy migration to strong authentication when desired. While the use of digital certificates should be supported, other authentication methods should also be an option.

### BRIEF SUMMARY OF THE INVENTION

The present invention is directed to an apparatus and method of providing additional authentication for a network based application. According to the invention there is provided proxy based monitoring which detects and intercepts login data being sent to the application. This data is redirected to an authentication process which verifies enrollment and then performs strong authentication. Authentication is achieved by requesting a digital certificate, or similar data, from the users computer without involving the user. If authentication fails, the login data is withheld from the application, preventing login.

According to an aspect of the invention the authentication is adaptive to the state of the user, performing authentication for those enrolled and allowing normal login to proceed unhindered for those not enrolled.

According to another aspect of the invention enrollment occurs automatically, with no user involvement beyond the initial request. Initial validation is performed by confirming successful login with the supported application. Generation and storage of keys and certificates is handled by interaction between the authentication server and software on the user's computer, typically the web browser.

Further in accordance with the invention non-generated data, such as that stored by hardware keys, can also be used for authentication.

The advantages of such a method and apparatus are simplified enrollment by the user, simplified addition of authentication to an existing application, and transparent authentication once the user is enrolled.

The above and other features and advantages of the present invention will become more clear from the detailed description of a specific illustrative embodiment thereof, presented below in conjunction with the accompanying drawings.

### BRIEF DESCRIPTION OF THE SEVERAL VIEWS OF THE DRAWINGS

FIG. 1 is a block diagram of the hardware major components comprising the inventive system.

FIG. 2 is a flow diagram for the monitoring process.

FIG. 3 is a flow diagram for the authentication process.

FIG. 4 is a entity communication model showing messages exchanged during a login attempt where the user is not enrolled.

FIG. 5 is a entity communication model showing messages exchanged during a successful authentication and login attempt where the user is enrolled.

FIG. 6 is a entity communication model showing messages exchanged during a failed authentication attempt for an enrolled user.

FIG. 7 is a entity communication model showing messages exchanged during a login attempt where authentication succeeds but application login fails.

FIG. 8 is a flow diagram of the enrollment process.

FIG. 9 is a entity communication model showing messages exchanged during the enrollment process.

FIG. 10 is a block diagram of a typical prior art network based application.

FIG. 11 is block diagram of a typical prior art digital certificate based authentication system.

### DETAILED DESCRIPTION OF THE INVENTION

The following discussion focuses on the preferred embodiment of the invention, in which digital certificates are used to validate access to an Internet hosted application server. However, as will be recognized by those skilled in the art, the disclosed method and apparatus are applicable to a wide variety of situations in which validation of user access to a network hosted application is desired. The use of digital certificates is only one exemplary method, any method in which some type of electronic token or key is issued or otherwise available to a user, and later checked, may be supported by the present invention.

Glossary

The following is a brief glossary of terms used herein. The supplied definitions are applicable throughout this specification and the claims unless the term is clearly used in another manner.

Authentication server—that component of the present invention which performs the strong authentication of users and the assignment of certificates or other data used in the strong authentication process.

Client application—existing software application to be supplemented by the present invention for purposes of increasing the level of security.

Client application server—system which hosts or provides access to the client application.

Public Key Infrastructure (PKI)—the protocols, services, and standards supporting applications of public-key cryptography. Herein, specifically such an infrastructure providing public key-based security services through a system of digital certificates, certificate authorities, and other registration authorities to validate and authenticate each party involved in a computer based transaction.

Public-Key Cryptography Standard (PKCS)—A series of cryptographic standards dealing with public-key issues, published by RSA Laboratories.

Proxy server—a server which acts as an intermediary between an application user and the application. When the proxy server receives a request from the user, the proxy server places the request with the application on behalf of the user and then forwards the results of the request to the user. Commonly used between a web browser and the Internet to provide firewall or other services. Herein, it is used to monitor and intercept communication between a user and the client application.

User—entity requesting service from the client application. While this is typically a human using a personal computer or equivalent, the term has a broader definition as used herein. It is also intended to encompass situations in which one computer or system of computers, requests service from another. Where the user is a human, the actual “user” interaction may take place with the browser application, or equivalent, used by the human with human input where necessary.

### PREFERRED EMBODIMENT

The disclosed invention is described below with reference to the accompanying figures in which like reference numbers designate like parts. Generally, numbers in the 200's refer to prior art elements or elements in the surrounding environment while numbers in the 100's refer to elements of the invention.

Overview

The inventive system presents a user friendly strong authentication system, and method of using, which is almost entirely transparent to the user. Activation of strong authentication is via one-click enrollment, after which authentication is performed by monitoring and intercepting messages used in the standard login sequence. User validation for purposes of enrollment is achieved by confirming successful logon to a client application. Encryption keys and a digital certificate are generated and stored through interaction between the user's browser and elements of the inventive system with no user involvement.

Until the user elects to activate strong authentication, the inventive system continues to support weak authentication via the client application. After enrollment, strong authentication is performed automatically. This adaptive approach allows for seamless, transparent migration from weak to strong authentication and allows for different users operating at different levels of authentication.

With the inventive system and method in place, two factor authentication is provided, the first by the application and the second by the inventive system. While the preferred embodiment is described herein as implemented with a user password as the application supported, weak, authentication method and a digital certificate as the strong authentication method, this is not a limitation of the invention. A wide variety of other application supported methods could be used as long as the logon process is detectable via proxy monitoring and can be confirmed by querying the application. It is even possible that the application's native authentication approach be one of the strong methods, resulting in two factor authentication where both provide strong authentication. Similarly, other authentication methods could be supported by the inventive system as the second factor, as long as the required data (certificates, tokens, etc.) can be automatically generated, or retrieved, by the system and corresponding data stored by or available to the user's browser or host system. An example is the use of a hardware key wherein a key is attached to the user's computer. The key identifier can be retrieved and stored during enrollment and then verified during authentication.

Architecture

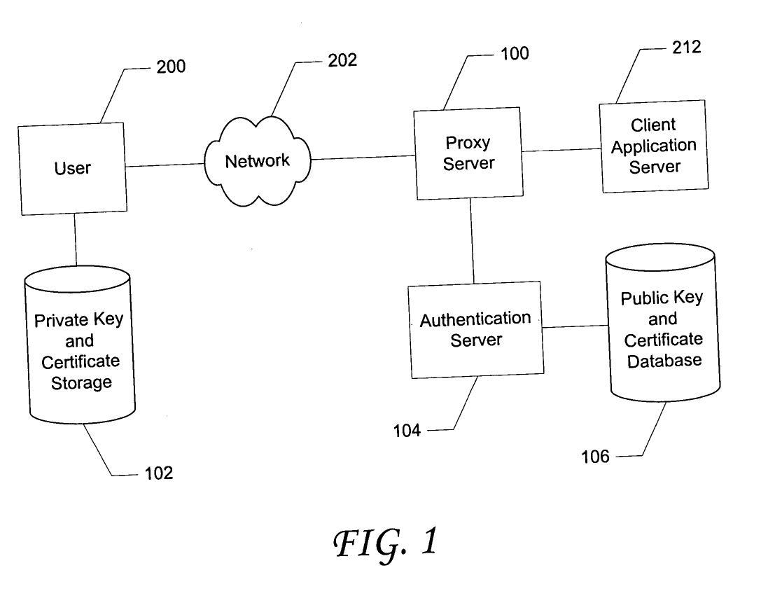

The general architecture of the inventive system is presented in FIG. 1. The user, 200, and network, 202, perform much as described in the background section, supra, with the client application server, 212, filling the role of application server. Only their functionality which is specific to the present invention is described here. The most significant elements are the proxy server, 100, and authentication server, 104.

Note that while the proxy server and authentication server functions could be combined into a single component they are described separately herein for clarity and to distinguish their functions. Also note that while the client application is assumed to be hosted on a separate server, this is not a requirement. Indeed, all three of these components could reside on the same hardware system.

The proxy server, 100, intercepts and forwards all inbound messages destined for the client application server, 212, and all outbound messages sent by the client application server to a user. This allows the proxy server to monitor all communications between the client application, hosted on the client application server, and the user, 200. It also allows the proxy server to block, redirect, or delay messages as necessary.

The authentication server, 104, handles all processing and storage associated with the selected strong authentication method as well as determining whether strong authentication has been enabled for a particular user. The authentication server utilizes the public key and certificate database, 106, to store the public keys and digital certificates for those users who have activated strong authentication. While the authentication process could be performed without this data, only the root Certificate Authority certificate being required, it is maintained for book keeping and revocation purposes. Each user will also maintain a private key and certificate storage, 102, on their computer. This allows them to sign, or encrypt, messages using the private key, and to provide the digital certificate when required for authentication.

Operation

The operation of the inventive system is described below. The discussion is divided to sections addressing the monitoring performed by the proxy server; the authentication performed by the authentication server; and the process of enrolling a user.

Monitoring

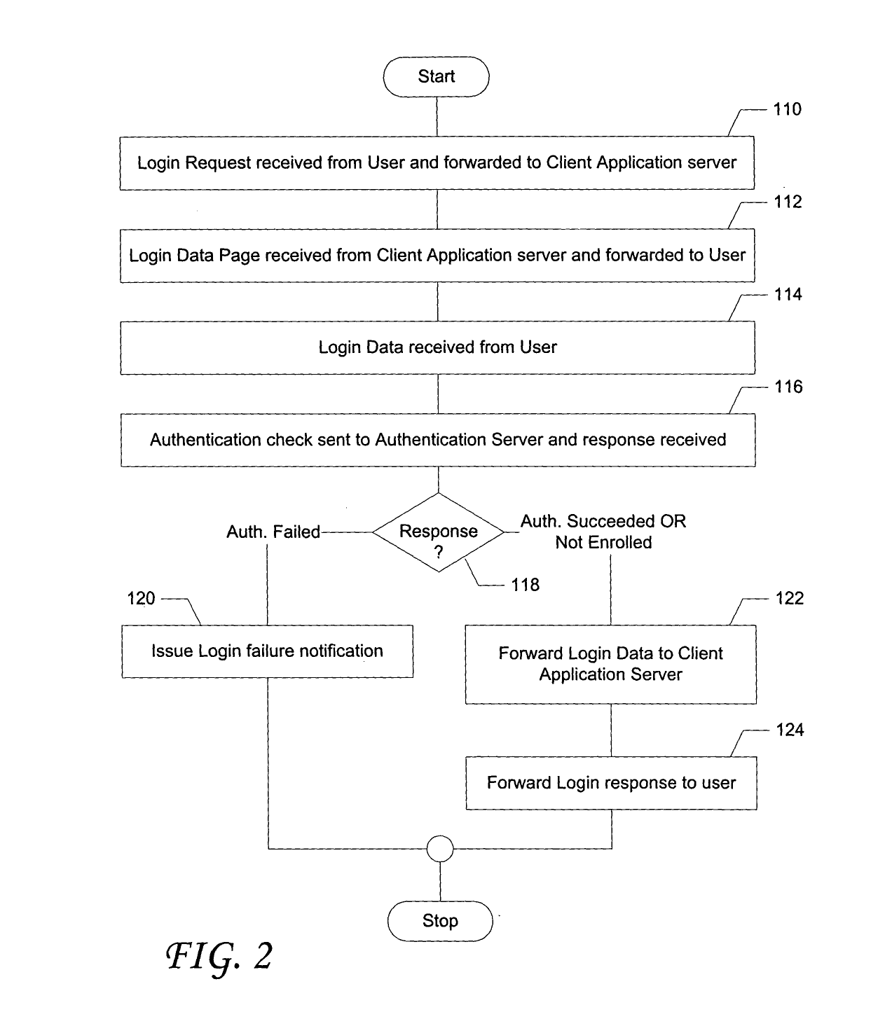

FIG. 2 presents the logical flow of the monitoring process as it occurs at the proxy server, 100 in FIG. 1. Note that this process occurs continually and for every user accessing the client application. FIG. 2 presents only a single pass through the logic. The illustrated process begins when a login request is received from the user, step 110. Prior to this point, the proxy server is monitoring message traffic, filtering messages and attempting to identify a login request. This data stream monitoring may be searching for specific uniform resource locators (URLs); specific keywords; or may be matching a specified template. The specific method is not critical as long as a user login request can be identified. Where templates are used, they may be maintained by either the proxy server or the authentication server. Alternatively, the client application response to the request could be identified in a similar manner.

With the login request identified, the processing represented by the logical flow chart of FIG. 1 is entered. The login request is forwarded to the client application, 213, step 110, for normal processing. This will result in a login data page being sent to the user requesting their conventional login data. The login data page is forwarded to the user, step 1 12. When the complete page, complete with login data is received by the proxy server, step 114, it is not immediately forwarded to the client application. Instead, all or part of the login data is diverted to the authentication server. The authentication server performs its strong authentication and responds to the proxy server with the result, step 116. Note that the authentication server performs a significant amount of processing in generating the response. This processing includes communicating with the user by relaying messages through the proxy server. This is largely transparent to the monitoring process and is discussed in detail below.

The authentication server's response is examined at step 118. If the user has enrolled in strong authentication, and the strong authentication check failed, a failure message is sent to the user, step 120, and the user's login data is discarded without having been sent to the client application. Two other possibilities exist: 1) the user has not enrolled in strong authentication; or 2) the user has enrolled and was successfully authenticated. These two cases are handled in the same manner by the proxy server: the previously intercepted login data is forwarded to the client application, step 122, and the client application's response to that data is returned to the user, step 124. These two cases can be handled in the same manner because in both cases the user's authentication is now dependent on the client application's determination. Where the user has not enrolled, that determination is the sole authentication and where the user has enrolled, that determination is the second factor in a two factor authentication. Either way, the final determination is made by the client application without further action by the proxy server.

Two important points should be noted. First, the above data stream monitoring can be performed by the proxy server with no modification to either the client application or the client application server. They function just as they would if the present inventive system were not present. Second, the login failure message sent by the proxy server on a strong authentication failure is preferably identical to that generated by the client application if there is a weak authentication failure. This helps make the addition of the strong authentication process transparent to the user and increases security by not indicating to the user which authentication step failed or even that strong authentication is being performed

An alternative embodiment could utilize data other than a login request to authenticate a user. Any uniquely identifiable item of data, such as a credit card number or account number, could be used as the basis for authentication. the only requirement is that it be detectable by the monitoring process and be unique to each user. This would allow the present inventive system to be used to add authentication to a client application which currently does not use an authentication process.

Authentication

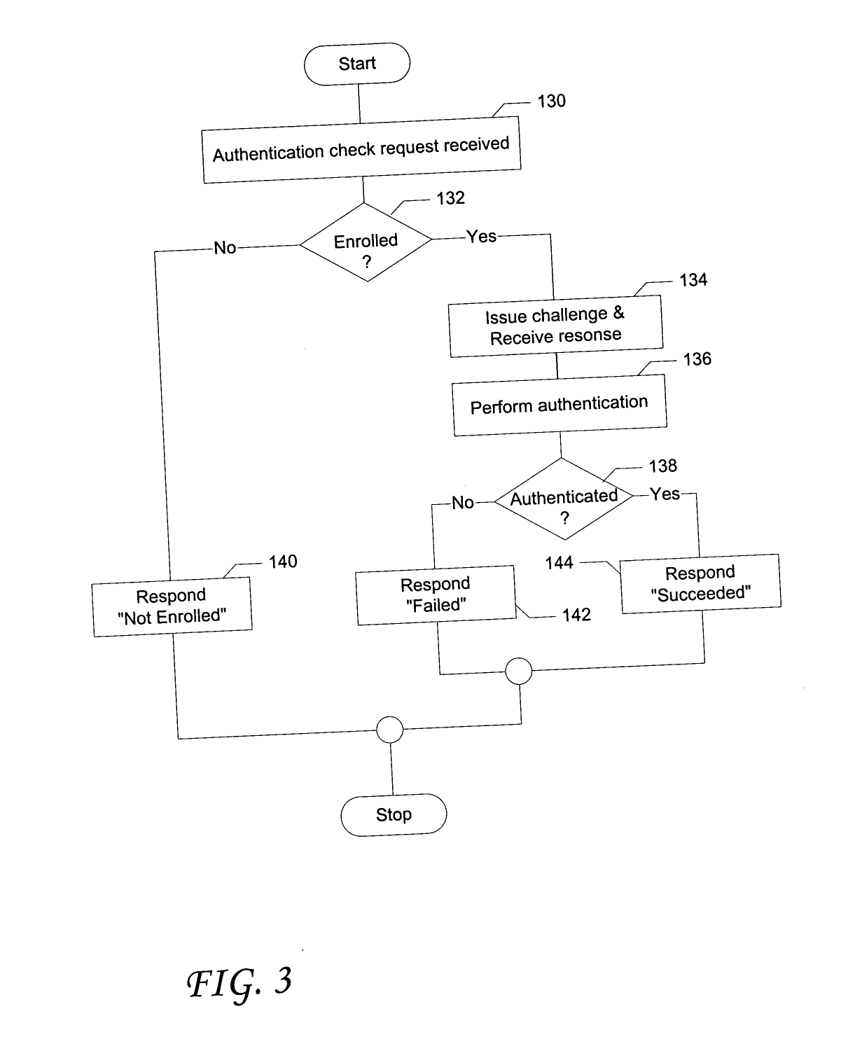

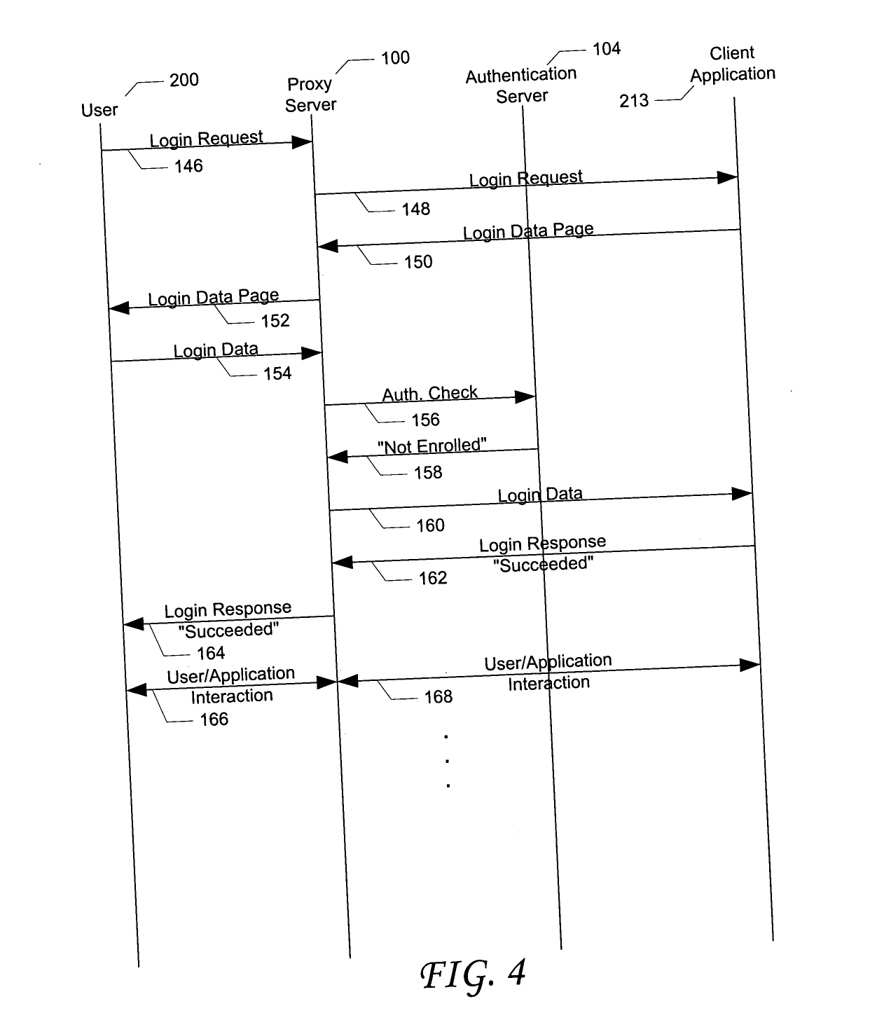

The details of the strong authentication process performed by the present invention are best understood by examining the processing performed by the authentication server, 104 in FIG. 1, and the messages exchanged by the entities involved. This will be discussed below with reference to FIGS. 3-7. FIG. 3 is a logical flow chart for the authentication server while FIGS. 4-7 are entity communication models. The vertical lines represent the various entities involved while the horizontal lines represent messages transmitted between entities. The sequence of messages corresponds to their arrangement from top to bottom. Note that if only those messages involving the authentication server are considered, the sequence in a particular diagram corresponds closely to a single path through the flow chart of FIG. 3. Unless otherwise specified, “steps” will refer to FIG. 3 and “messages” will refer to one of FIGS. 4-7.

The authentication server is not involved with the monitoring activity performed by the proxy server and thus only sees messages, and performs processing, directly related to authenticating a user. Several possibilities exist, and they will be discussed separately for clarity. It should be understood that these are merely different logical paths through the same process.

The simplest case is the one in which the user has not enrolled in strong authentication. This situation is illustrated in FIG. 4 and corresponds to taking the “No” branch at decision step 132, in FIG. 3. Messages 146 through 154 correspond directly to steps 110 through 114 in FIG. 2, do not involve the authentication server and so will not be discussed further. Message 156 is the first point at which the authentication server becomes involved. The authentication check is a request from the proxy server to determine whether the user is authorized. The message includes at least a subset of the login data supplied by the user to a normal login request to the client application. This will include some unique identifier, such as a user id, by which the user will be known to the authentication server. First, at step 132, the authentication server will check its certificate database to determine if the user has an entry. If no entry is found, the user is not enrolled and a “not enrolled” message, 158, is returned to the proxy server. Messages 160 through 164 correspond to steps 122 and 124 in FIG. 2 and represent the normal login completion sequence for the client application. Assuming the user successfully logged in to the client application, messages 166 and 168 represent the communication between the user and the client application which are forwarded, as needed, by the proxy server.

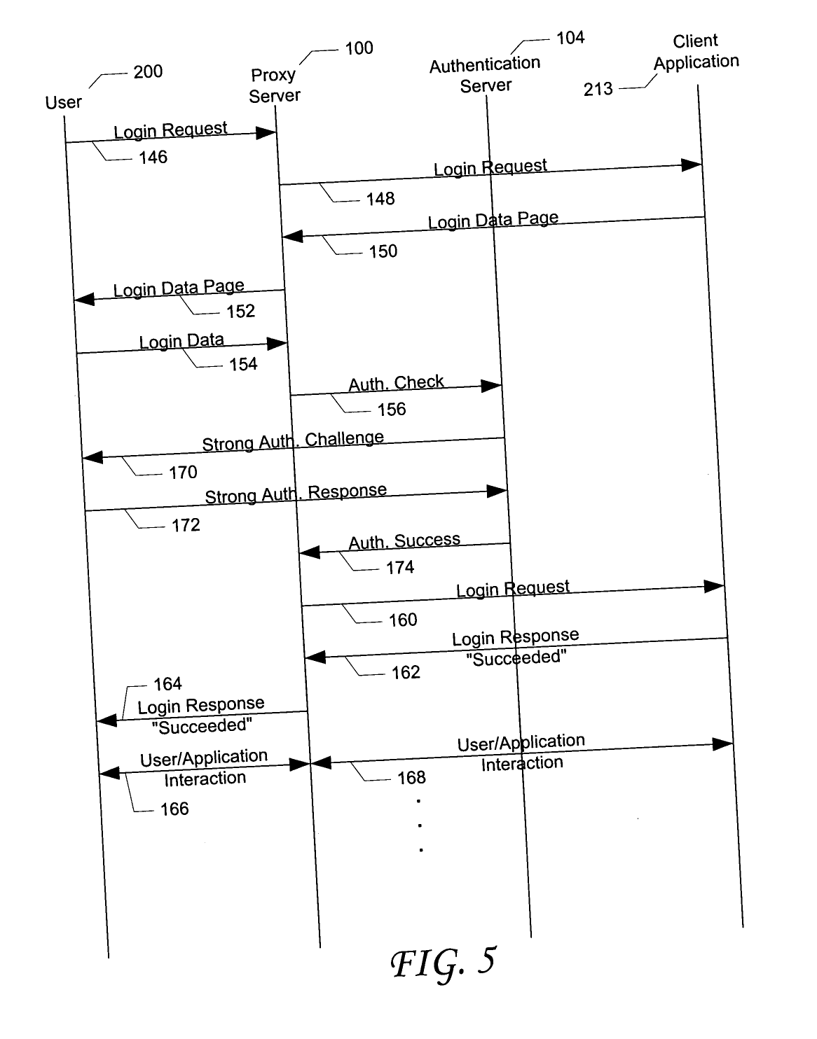

The second situation is where the user has enrolled and successfully authenticates and logs in to the client application. Referring to FIG. 5, the sequence is the same as for FIG. 4 through message 156. However, in this situation, when the check at step 132 is performed, an entry corresponding to the user is found in the certificate database. The authentication server then begins the process of authenticating the user. In the preferred embodiment, this involves first generating and transmitting a challenge to the user, step 134 and message 170, to which the user responds, message 172. This is done in a manner consistent with NIST FIPS 196, supra. The critical part of this exchange is that the user's response includes the user's digital certificate. This certificate can then be validated, step 136, by the authentication server in a conventional manner as is well known in the art. For the present situation, this validation succeeds, resulting in the user being authenticated, step 138. A “success” message, 174, is sent to the proxy server, step 144, which then allows client application login and user-application interaction to proceed normally, as above. Note that the login success message, 164, sent to the user is the same in both of the first two situations. Where the user successfully authenticates and then logs in, or just logs in, the appearance is identical to the user.

It is important to note that the user authentication response message, 172, is automatically generated by the user's computer with no human interaction. Preferably, this is handled by the user's web browser, most of which have the ability to respond to a challenge and provide a digital certificate built in. In this manner, the second factor, strong, authentication performed by the inventive system is entirely transparent to the user.

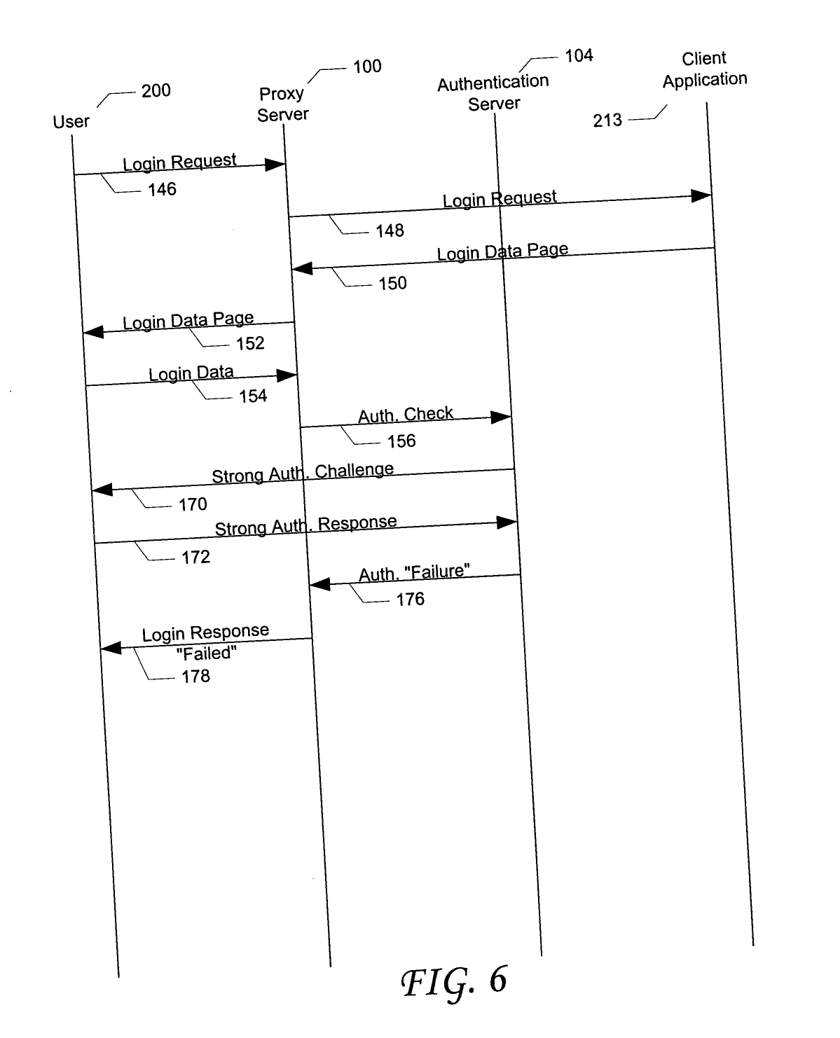

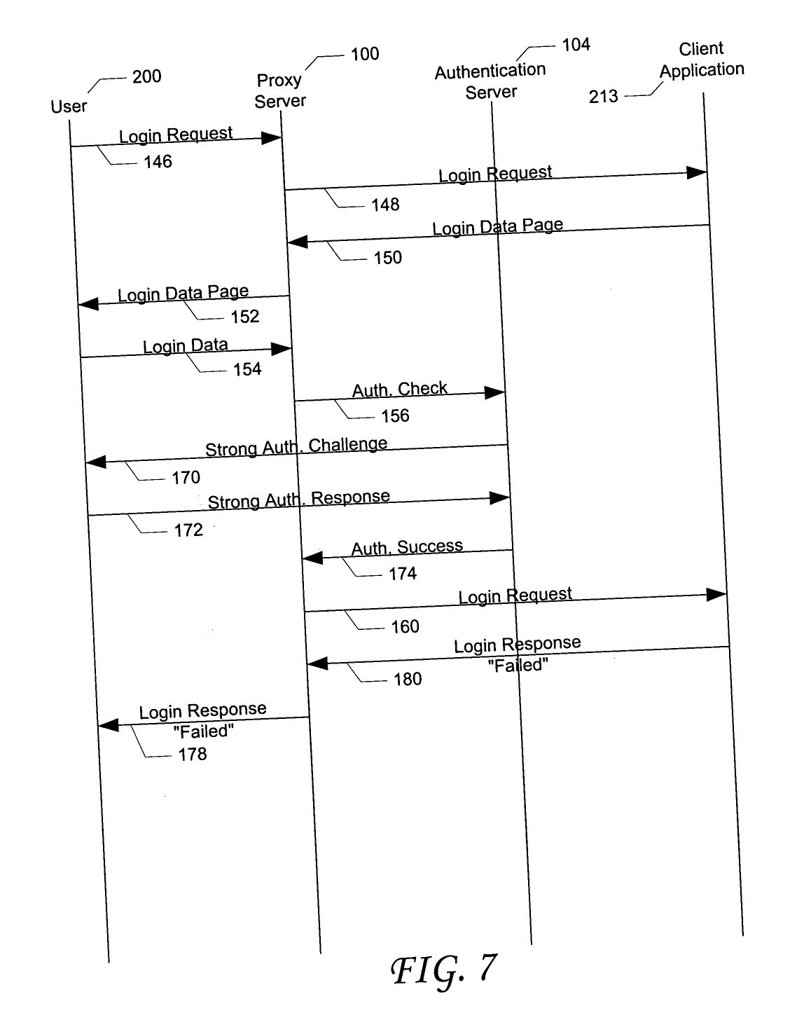

FIG. 6 illustrates the message sequence for the situation in which there is an authentication failure. The sequence is the same as for a success, through message 172. However, when the user certificate is validated in step 136, the validation fails and the user is not authenticated, step 138. An authentication failure message, 176 is returned to the proxy server, step 142, which, in turn, issues a login failure response, 178 to the user. Note that because authentication failed, the login data is not sent to the client application and there is no opportunity for the user to log in to the application.

Where there is an authentication success followed by a failure to login to the client application, the sequence is as presented in FIG. 7. This might occur in a situation such as where the user has the correct certificate, but enters the password incorrectly. The sequence is the same as for a successful login, as in FIG. 5, through message 174. When the login data is forwarded to the client application as login request, 160, the client application determines that the login is incorrect and responds with a login failed response, 180. This is forwarded to the user as login failure response 178. Note that, just as in the case of the success messages, the two failure cases present the same failure message to the user to preserve the transparency of the authentication and to hide the information about which authentication factor failed. Alternatively, of course, distinct messages could be used for each success and/or failure case.

Note that in the above case in which the user was authenticated but failed to login, the authentication remains in effect. The user can attempt to login again, and the authentication process will be skipped. The user can attempt to login as many times as allowed by the client application. If the user ultimately fails to log in successfully, the authentication will time out at a specified time period and the user will have to re-authenticate in order to try to login again.

A similar process is used to terminate authentication when the user has successfully authenticated and logged in. A timeout feature will terminate the authentication after a specified period of user inactivity. This activity can be detected by the monitoring feature of the proxy server and reported to the authentication server. Alternatively, the proxy server can detect an explicit logout by recognizing either a request from the user or a message from the client application. This may be used in place of or in combination with the timeout capability.

An important feature of the inventive system, as illustrated above, is that it is adaptive to the specific user. For those users who have not enrolled in the inventive system's second, strong, authentication factor, the normal client application log in procedures are still used, with no impact to the user. For those users who have enrolled, two separate checks are performed, again with no apparent impact on the user. The authentication check is performed automatically with no further user input required. Once a user has enrolled, strong authentication will be required for all login attempts from then forward.

Enrollment

As with authentication, enrollment is transparent, or almost so, to the user. At least two alternatives exist, and both are anticipated to be used. In the first, a “one click” enrollment option is presented to the user. An example would be an enrollment button presented on the login screen. When the user presses the button, the enrollment process is triggered and completes with no further user interaction.

The second alternative is automatic enrollment. The system administrator selects a set of users, possibly all users, to be enrolled. The next time that they login, they are recognized and the enrollment process triggered. As in the first alternative, the enrollment process completes with no user interaction. A further alternative is to trigger automatic enrollment when some threshold criteria is met. This may be almost any criteria believed to indicate a need for increased security such as access to specified resource or type of resource, number of connect hours, time of day or day of week (i.e. evening or weekend) when a connection is made, etc.

This ability to enroll a user with no interaction beyond the initial, optional, request is an important feature of the inventive system. By minimizing the impact on the user, acceptance is significantly increased and with it, usage of strong authentication. This is in sharp contrast to the sometimes burdensome requirements of the prior art systems which act as a deterrent to use.

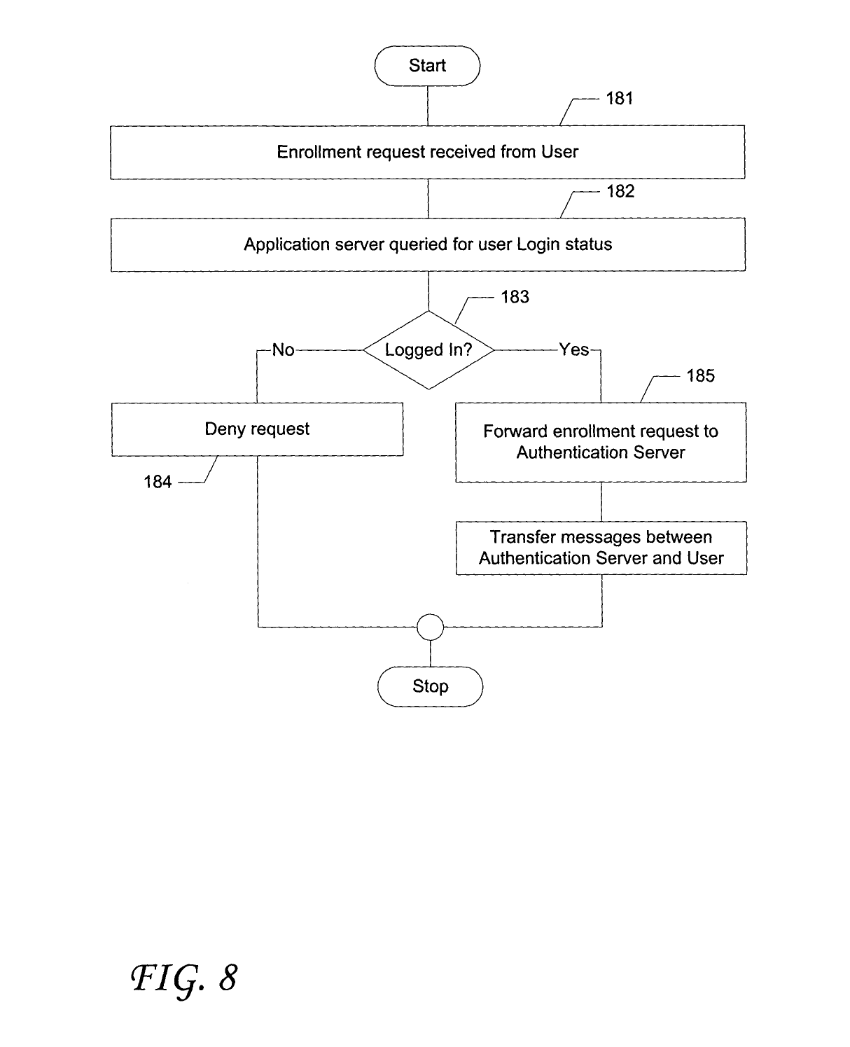

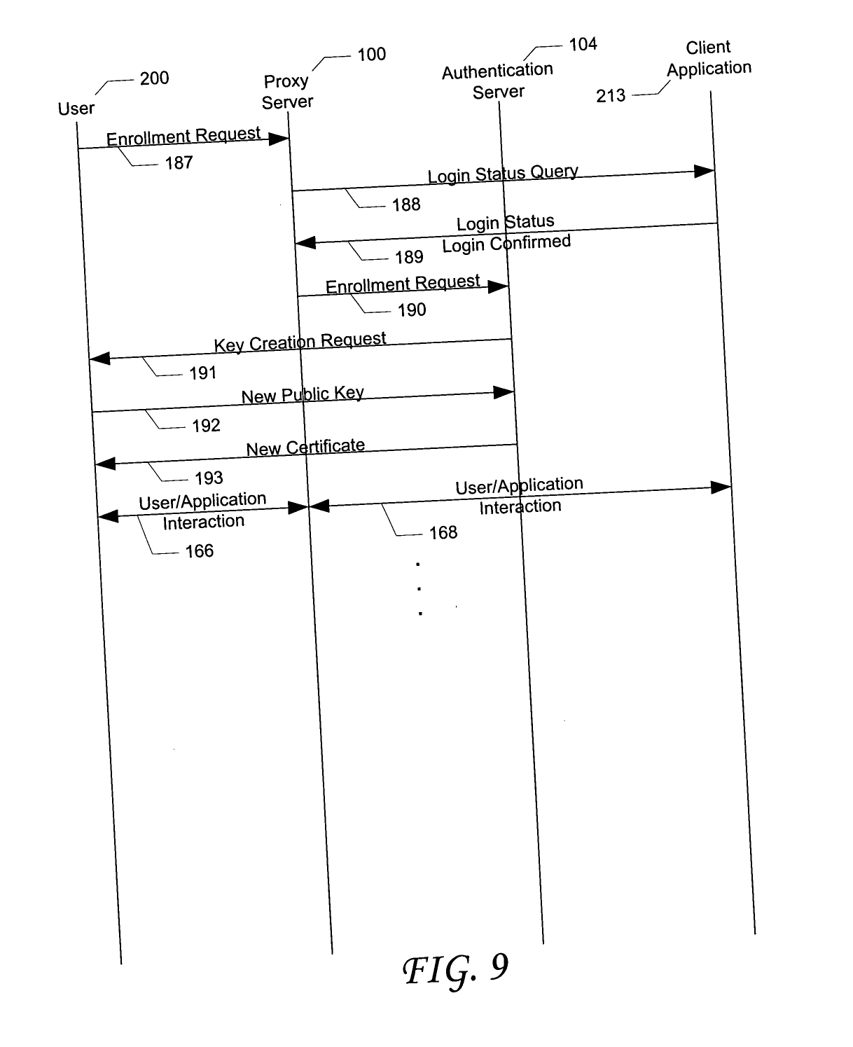

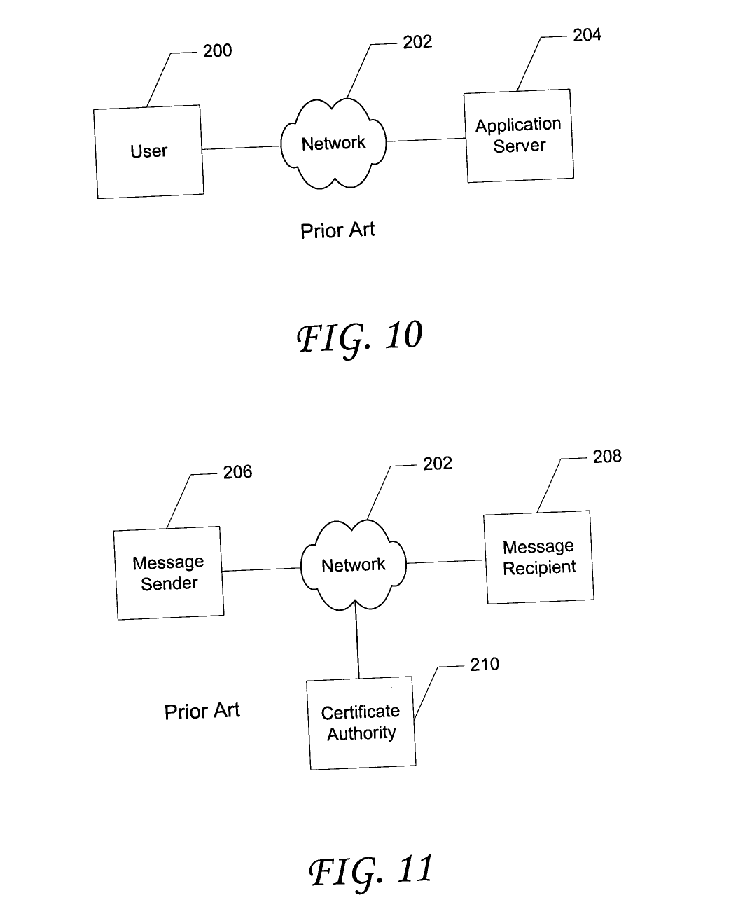

The key to the low impact enrollment offered by the inventive system is the method of validation used. The core concept is that the inventive system relies upon the client application to confirm that the user is successfully logged in. The details of how this is achieved, along with a description of the entire enrollment process follows with reference to FIGS. 8 and 9. As above, “steps” refer to the flow chart, FIG. 8, while “messages” refer to the interaction diagram, FIG. 9. Note that FIG. 8 represents the logic flow for the proxy server.

The first step in enrollment is the receipt of an enrollment request from the user, step 181, message 187. This message is generated by the user's button press or by recognition of a user selected for enrollment. Preferably, either the message include the user's identifier or the identifier can be retrieved from the client application based on a unique session ID. This is the same identifier as discussed above with respect to authentication. Note that this feature allows authentication to be performed based on the login ID used by the client application rather than requiring a new identifier. The next step, 182, is to query the client application to determine the user's login status by sending query message, 188, and receiving reply message, 189.

The login status query message, 188, and login status reply, 189, could take many forms. Any protocol which uniquely identifies the user and provides a confirmation would be applicable. In the preferred embodiment, the client is presumed to provide an enrollment authorization page (e.g. EnrollAuthorization.jsp) in a protected directory. This authorization page is accessible to a user only after the user has logged in to the application. A typical authorization page might include the following fields for the logged in user: user_id; email; company; department; city; state; county. The page also contains a custom http response header ( e.g. EnrollAuthorization) with value “yes” to indicate that the user is authorized to enroll. The login status query message comprises a request to the application web server for this enrollment authorization page. If the user has not logged in, the request is denied. If the user has logged in, the client application replies with the authorization page and the custom HTTP response header.

Typically, the preferred method, or another accepted method will already be supported by the client application. In some instances, it may be necessary to modify the client application to provide an acceptable mechanism.

The proxy server examines, step 183, the login status message, 189, to determine whether the user is currently logged in. If not, the enrollment request is denied, step 184. If the user is logged in, an enrollment request, 190, is sent, step 185, to the authentication server. The proxy server then forwards a series of messages between the authentication server and the user.

In the preferred embodiment, the sequence of messages used to effect the enrollment conforms to NIST FIPS 196. Clearly, other protocols are also applicable. The first message, 191, is sent from the authentication server to the user, or more specifically, the user's browser, to request the creation of a private/public key pair. The user's browser creates the key pair, stores the private key locally, and sends a certification request, preferably in PKCS #10 format, containing the public key, to the authentication server, message 192. Using the public key, the authentication server, acting as a certificate authority, creates and digitally signs a digital certificate which is sent back to the user's browser, 193, preferably in PKCS #7 format. The certificate, possibly in combination with other user data is also stored by the authentication server in its database, element 106 in FIG. 1. This storage is not required for authentication, but is done for book keeping and revocation purposes. The authentication server can validate a certificate which it has issued using only its root certificate authority certificate.

With the enrollment complete, the user's current session continues unaltered. The user is not required to log out and re-authenticate. This would be a burden to the user and would add no increased security since the entire enrollment process was authorized based on the existence of the current session.

Advantages

The advantages of the inventive system and method are several but generally fall into the area of simplicity and transparency. Enrollment involves no more effort on the user's part than clicking one button. The required processing is done automatically and behind the scenes. Once enrolled, strong authentication is performed in a manner which is completely transparent to the user. The system adapts automatically to the level of authentication available for any one user. If the user has enrolled, a strong authentication check is performed by the inventive in addition to the client application's check, otherwise the client application performs its login check unhindered by the inventive system.

The inventive system and method also provide simplicity from the perspective of the client application developer. An existing web application can add the benefits of strong authentication without requiring any modification. In general, the web application can be integrated with the inventive system without the expense and time involved in using PKI toolkits and PKI APIs. Deployment of the new capability can be done with minimal impact on the application's users. User enrollment is done on the fly, as requested by the users or system administrator and no user data synchronization is needed before the system is deployed.

While the preferred form of the invention has been disclosed above, alternative methods of practicing the invention are readily apparent to the skilled practitioner. The above description of the preferred embodiment is intended to be illustrative only and not to limit the scope of the invention.

1) Where a computer based client application is hosted on an application server and provides at least one service to a user computer by means of a data network interconnecting the application server and user computer, a system for providing user authentication comprising:
a) a proxy server interposed between the application server and the data network whereby all data transferred between the application server and the data network is intercepted by said proxy server;
b) an authentication process adapted to perform authentication of one or more unique identifiers in response to one or more external requests comprising said unique identifier and to not perform authentication of one or more other of said unique identifiers; and
c) a monitoring process, executing on said proxy server and in communication with said authentication process, which examines at least some of said intercepted data, selectively redirecting certain data and forwarding other data, at least some of said redirected data comprising login data being transmitted to the client application and is redirected to said authentication process as one of said external requests;
wherein, said authentication process transmits at least a success and a failure message to said monitoring process depending on the result of said authentication, and said monitoring process is responsive to said success message by then forwarding said login uata to the client application and permitting continued communication between the client application and the user computer and responsive to said failure message by not forwarding said login data.

2) The user authentication system of claim 1 wherein said authentication process maintains a non-volatile store of enrollment data uniquely corresponding to at least a subset of said unique identifiers and wherein said authentication comprises an initial determination of whether enrollment data corresponding to a received unique identifier exists in said store and if not, the transmission of a not-enrolled message to said monitoring process, and wherein said monitoring process is responsive to said not-enrolled in the same manner as to a success message.

3) The user authentication system of claim 2 wherein the client application maintains login status data for users currently logged in to the client application and is capable of supplying said login status data upon request, and wherein said authentication process requests said login status data to validate a user prior to creating said enrollment data corresponding to said user.

4) The user authentication system of claim 3 wherein said login status data comprises a unique identifier corresponding to each of said users currently logged in and wherein said non-volatile store of enrollment data is indexed by said unique identifier.

5) The user authentication system of claim 3 wherein, if enrollment data corresponding to a received unique identifier exists in said non-volatile store said authentication process will not remove said enrollment data, will not transmit a non-enrolled message if said enrollment data exists, and will only transmit a success message if said authentication succeeds, whereby once a user has enrolled, that user must be successfully authenticated to gain access to the client application.

6) The user authentication system of claim 1 wherein said user computer stores unique digital identification data, said authentication comprises the steps of requesting said digital identification data from said user computer and verifying that said digital identification data corresponds to said unique identifier.

7) The user authentication system of claim 6 wherein said digital identification data is generated by said authentication process during an enrollment process and transmitted to the user computer for storage and later retrieval.

8) The user authentication system of claim 6 wherein said digital identification data is an identifying value associated with a hardware device accessible by the user computer.

9) Where a user, through the use of a user computer accesses a client application executing on a remote application server, the user computer and application server being in data communication through a network, a method of authenticating the user comprising:
a) monitoring communication between the user computer and the client computer application;
b) intercepting user login data sent from the user computer to the client application;
c) providing said user login data to an authentication process;
d) said authentication process distinguishing an enrolled from a non-enrolled user and authenticating only an enrolled user; and
e) withholding said user login data from the client computer application if the user is enrolled and was not successfully authenticated.

10) The method of authenticating of claim 9 further comprising said authentication process enrolling one or more users.

11) The method of authenticating of claim 10 wherein said process of enrolling one or more users comprises verifying that the user being enrolled is currently logged in to the client application as a requirement of enrolling.

12) The method of authenticating of claim 10 wherein said process of enrolling the user is initiated in response to said process of monitoring recognizing login data associated with a previously specified user.

13) The method of authenticating of claim 9 wherein said authentication process has access to account state information for at least some users, said account state comprising whether the users are enrolled.

14) The method of authenticating of claim 13 further comprising an enrollment process which alters said account state information to indicate that a user is enrolled.

15) The method of authenticating of claim 14 wherein said enrollment process communicates with the client application to determine if the user attempting to enroll is currently logged in to the client application and not enrolling the user if not logged in.

16) The method of authenticating of claim 14 wherein once said account state indicates that a particular user has been enrolled, said enrollment process and said authentication process will not further alter said account state to indicate that said particular user is not enrolled.

17) The method of authenticating of claim 9 wherein said step of authenticating the user comprises validating a digital identification value supplied by said user computer.

18) The user authentication system of claim 17 wherein said digital identification value is a unique identifier value associated with a hardware device connected to the user computer.

19) The method of authenticating of claim 17 further comprising an enrollment process which generates said digital identification value and transmits it to the user computer, said user computer storing said digital identification value for use during authentication.

20) The method of authenticating of claim 19 wherein said digital identification value is a digital certificate.

21) The method of authenticating of claim 19 wherein said enrollment process comprises determining whether the user attempting to enroll is currently logged in to the client application and enrolling the user only if logged in.

22) The method of authenticating of claim 21 wherein said step of authenticating the user is performed only for those users which have been enrolled.

23) The method of authenticating of claim 22 wherein once a user has been enrolled, authentication will always be performed for all login attempts.

24) Where a user computer is interconnected with a client application server by means of a general purpose computer network; where the client application server provides access to a client application by at least one user utilizing the user computer, a method of providing additional authentication of the user comprising:
a) interposing a proxy server between the client application server and the network;
b) providing an authentication server in communication with said proxy server;
c) providing a monitoring process on said proxy server to detect and intercept a unique identifier transmitted from the user computer to the client application server;
d) transmitting said unique identifier to an authentication process executing on said authentication server;
e) said authentication process validating the unique identifier as being bound to an entity authorized to access the client application server, transmitting a success message to said monitoring process if the entity is authorized, and transmitting a failure message to said monitoring process if the entity is not authorized;
f) said monitoring process responsive to said success and failure messages by allowing further communication between the user computer and the client application server only after receipt of said success message.

25) The method of providing additional authentication of claim 24 wherein said authentication process maintains a store of known entities for which authentication is to be performed and is responsive to the receipt of said unique identifier by transmitting a not-enrolled message to said monitoring process if said unique identifier does not correspond to one of said entities for which authentication is to be performed and by performing said validation if said unique identifier does correspond to one of said entities for which authentication is to be performed, and said monitoring process is responsive to said not-enrolled message by allowing further communication between the user computer and the client application server.

26) The method of providing additional authentication of claim 25 wherein said monitoring process is responsive to a supplied list of at least one unique identifier by scanning communications transmitted to the client application server and upon detecting a transmission containing one of said at least one unique identifiers, forwarding said transmission to said authentication process, and said authentication process responsive to said forwarded transmission by adding the entity associated with said forward transmission to said store of known entities for which authentication is to be performed.
